(19) United States
(12) Patent Application Publication
(10) Pub. No.: US 2005/0086266 A1
(43) Pub. Date: Apr. 21, 2005

(54) Storage medium including meta information for search and device and method of playing back the storage medium

(75) Inventors: Man-seok Kang, Suwon-si (KR); Kil-soo Jung, Hwaseong-si (KR); Sung-wook Park, Seoul (KR); Kwang-min Kim, Anyang-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/973,290

(22) Filed: Oct. 27, 2004

(30) Foreign Application Priority Data
Oct. 30, 2003 (KR) 2003-76491
Jul. 2, 2001 (KR) 2004-51520

(51) Int. Cl. G06F 7/00

(52) U.S. Cl. 707/104.1

(57) ABSTRACT

A storage medium including meta information for a search, and a device and method of playing back the storage medium, includes: audio-visual (AV) data; at least one play item and at least one play list, each of which is a unit in which the AV data is reproduced; and at least one piece of meta information used to search for locations of AV data that satisfy externally input search conditions, by referring to the play item and the play list. Accordingly, motion picture data conforming to various search conditions desired by a user can be efficiently searched for and played back.

### CROSS-REFERENCE TO RELATED APPLICATION

This application claims the benefit of Korean Patent Application No. 2003-76491, filed on Oct. 30, 2003 in the Korean Intellectual Property Office, and Korean Patent Application No. 2004-51520, filed on Jul. 2, 2004 in the Korean Intellectual Property Office, the disclosures of which are incorporated herein in their entirety by reference.

### BACKGROUND OF THE INVENTION

1. Field of the Invention

The present invention relates to a playback of storage media, and more particularly, to a storage medium including meta information for a search and a device and method of playing back the storage medium.

2. Description of the Related Art

Storage media, such as digital versatile discs (DVDs), store audio-visual (AV) data (or a motion picture data stream) including a video, an audio, and/or a subtitle that are compressed (coded) according to a standard, such as, the motion picture experts group (MPEG). The storage media further store additional information, such as properties of coding of the motion picture data stream or a sequence of playing back motion pictures. Hence, motion pictures recorded in a storage medium are generally played back according to a playback sequence included in additional information. In some cases, the AV data may be searched for and played back on a chapter-by-chapter basis.

However, conventional storage media do not have a function in which a specific scene is searched for and played back according to a search basis desired by a user. More specifically, conventional storage media do not provide a function in which a specific part of the AV data is searched for and played back according to a search basis desired by a user, such as, a scene-by-scene search basis, a character-by-character search basis, a location-by-location search basis, or the like. Thus, conventional storage media cannot provide various types of search.

### SUMMARY OF THE INVENTION

Additional aspects and/or advantages of the invention will be set forth in part in the description which follows and, in part, will be obvious from the description, or may be learned by practice of the invention.

An aspect of the present invention provides a storage medium from which a motion image can be searched for and played back according to various search bases.

An aspect of the present invention also provides a device for searching for and playing back a motion picture according to various search bases.

An aspect of the present invention also provides a playback method including an extended motion picture search function according to various search bases.

According to an aspect of the present invention, there is provided a storage medium storing data, the data includes: audio-visual (AV) data; at least one play item and at least one play list, each of which is a unit in which the AV data is reproduced; and at least one piece of meta information used to search for locations of the AV data that satisfy externally input search conditions, by referring to the play item and the play list.

According to an aspect of the present invention, the meta information includes: search keyword information to be compared with the externally input search condition; and location information indicating a location of the AV data corresponding to the search keyword information.

According to an aspect of the present invention, the search keyword information includes: a search keyword to be compared with the externally input search condition; and a value of the search keyword and/or additional information about the search keyword.

According to an aspect of the present invention, the search keyword includes at least one of a search keyword for a scene-by-scene search, a search keyword for a character-by-character search, a search keyword for a music-by-music search, a search keyword for an item-by-item search, or combinations thereof.

According to an aspect of the present invention, the search keyword information further includes meta type information that indicates a type of the search keyword that can be arbitrarily designated by a manufacturer.

According to an aspect of the present invention, the location information includes: an identifier of the play item to which the meta information refers; and time stamp data indicating a time interval between a point in time when the play item starts being reproduced and a point in time corresponding to a location of AV data pointed by the meta information or a stamp of a duration while the location of the AV data pointed by the meta information is being played back.

According to an aspect of the present invention, the play item identifier is used to search for a play item to be played pack.

According to an aspect of the present invention, the point in time when the found play item starts being reproduced and the time stamp data is used to search for a location of a part of the AV data to be played back.

According to an aspect of the present invention, the meta information is included in a play list mark which is a collection of marks indicating locations of specific parts of the AV data that correspond to play lists, each of the play lists being a unit in which the AV data is reproduced.

According to an aspect of the present invention, the meta information is recorded separately from a play list mark which is a collection of marks indicating locations of specific parts of the AV data that correspond to play lists, each of the play lists being a unit in which the AV data is reproduced.

According to aspects of the present invention, the meta information may have a fixed length or a variable length.

According to an aspect of the present invention, the meta information further includes length information indicating a data length of the meta information.

According to aspects of the present invention, the meta information is recorded either in the form of binary data or in the form of text data and further include an additional description about the meta information.

According to another aspect of the present invention, there is provided a playback device including: a search unit searching a storage medium for a location of AV data that satisfies an externally input search condition, by referring to at least one piece of meta information included in the storage medium; and a playback unit reproducing the AV data from the location on the storage medium that satisfies the externally input search condition, where the data stored in the storage medium includes: audio-visual (AV) data; at least one play item and at least one play list, each of which is a unit in which the AV data is reproduced; and the at least one piece of meta information used to search for the locations of the AV data that satisfy the externally input search conditions, by referring to the play item and the play list.

According to another aspect of the present invention, there is provided a playback method including: receiving a predetermined search condition; searching a storage medium for a location of AV data that satisfies the predetermined search condition, by referring to at least one piece of meta information included in the storage medium; and reproducing the AV data from the location on the storage medium that satisfies the predetermined search condition, where the data stored in the storage medium includes: audio-visual (AV) data; at least one play item and at least one play list, each of which is a unit in which the AV data is reproduced; and the at least one piece of meta information used to search for the locations of the AV data that satisfy the predetermined search conditions, by referring to the play item and the play list.

### BRIEF DESCRIPTION OF THE DRAWINGS

The above and/or other aspects and advantages of the present invention will become more apparent and more readily appreciated by describing in detail exemplary embodiments thereof with reference to the accompanying drawings in which:

FIG. 1 illustrates a relationship between meta information according to an embodiment of the present invention and audio-visual (AV) data;

FIG. 2 is a block diagram schematically illustrating a data structure of a play list including the meta information of FIG. 1;

FIG. 3 illustrates an example of a sentence structure of a play list mark including the meta information of FIG. 1;

FIG. 4 illustrates an example of a table for a search keyword according to the meta information of FIG. 1;

FIG. 5 illustrates an example of a sentence structure of a play list mark including meta information according to another embodiment of the present invention;

FIG. 6 illustrates a relationship between meta information according to still another embodiment of the present invention and AV data;

FIG. 7 is a block diagram schematically illustrating a data structure of a play list including the meta information of FIG. 6;

FIG. 8 illustrates an example of a sentence structure of the meta information of FIG. 6, which is recorded separately from a play list mark;

FIG. 9 illustrates an example of a table for a search keyword of the meta information of FIG. 6;

FIG. 10 is a block diagram of a playback device according to an embodiment of the present invention;

FIG. 11 is a flowchart illustrating a playback method according to an embodiment of the present invention;

FIG. 12 illustrates an example of a sentence structure of a play list mark including meta information according to yet another embodiment of the present invention to which meta type information 1210 is added;

FIG. 13 illustrates an example of a play list mark including the meta information of FIG. 12;

FIGS. 14A and 14B illustrate search menu images formed using meta information according to an aspect of the invention;

FIG. 15 illustrates an example of a sentence structure of a play list mark including meta information according a further embodiment of the present invention to which meta type information 1510 is added;

FIGS. 16A and 16B illustrate examples of a play list mark including the meta information of FIG. 15; and

FIG. 17 illustrates an example of a sentence structure of meta information according to another embodiment of the present invention which is recorded separately from a play list mark and additionally includes meta type information.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

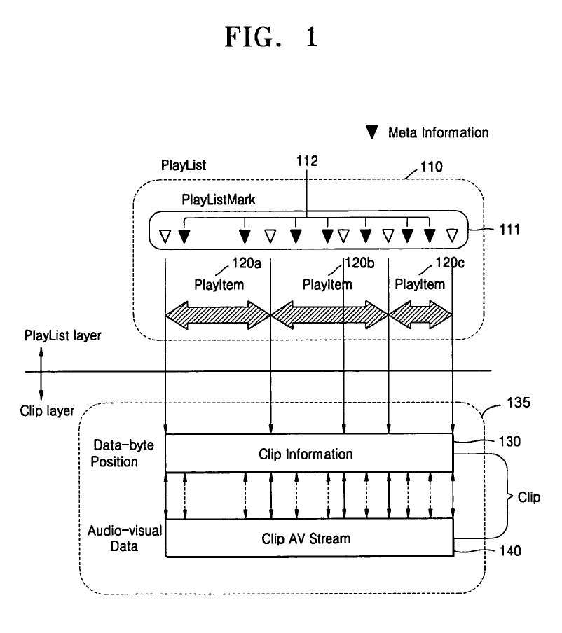

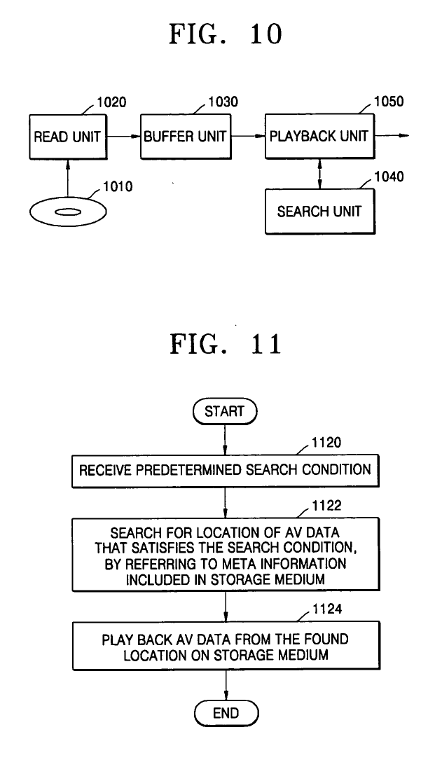

FIG. 1 illustrates a relationship between meta information 112 according to an embodiment of the present invention and audio-visual (AV) data. Referring to FIG. 1, a storage medium (such as the medium 1010 shown in FIG. 10) according to an embodiment of the present invention stores clips 135 and play lists 110, each of which is a unit of reproduction. Each of the clips 135 includes a clip AV stream 140, which is a unit of recording, and clip information 130. The play list 110 includes play items 120a, 120b, and 120c. The play list 110 further includes a play list mark 111 and meta information 112, which serves as a search basis according to an aspect of the present invention.

Compared with conventional DVDs, the clip AV stream 140 corresponds to a cell which is a unit of recording, and the play list 110 and the play items 120a through 120c correspond to a program chain, a program, and a cell which are units of reproduction. Motion picture data is recorded in a storage medium on a clip-by-clip basis. Hereinafter, the clip AV stream 140 is generally referred to as audio-visual (AV) data.

Typically, the AV data is recorded in consecutive spaces and compressed to reduce a volume of the AV data. To reproduce the compressed AV data, information about properties of the compressed AV data is needed. Accordingly, each clip 135 includes the clip information 130, which has information about properties of compressed AV data. However, it is understood that the clip 135 need not require the AV data to be compressed in all aspects of the invention.

The clip information 130 includes property information, such as, audio/video properties of the AV data 140, an entry point map in which information about a location of a randomly accessible entry point is recorded in units of a predetermined section, and the like. In the MPEG standards widely used in motion picture compression, an entry point is information about a location of an I picture into which an intra-image is compressed, and an entry point map is usually used in a time search for searching for a location on the storage medium over which a playback device is placed after the lapse of some period of time after data starts being reproduced. However, it is understood that other standards, such as Windows Media, can be used other than MPEG for compression.

The storage medium stores a plurality of play lists 110, each of which is a basic unit in which data is reproduced. Each of the play lists 110 includes the play list mark 111, indicating a specific location on the AV data, and at least one play item 120a, 120b, or 120c, which is a sub-unit in which the AV data is reproduced.

The play items 120a, 120b, and 120c indicate parts of the clip AV stream 140 by pointing out a playback start time and a playback end time included in the clip information 130. Hence, the play items 120a, 120b, and 120c each can find a location of a specific part of the AV data by using the entry point map included in the clip information 130.

The AV data is generally reproduced in units of a play list 110 in a sequence of play items 120a, 120b, 120c arranged in the play list 110. As such, a specific part of a motion picture stream can be searched for using the play list mark 111 and reproduced according to an aspect of the invention as explained in greater detail below.

To provide various searches according to various search bases desired by a user according to an aspect of the invention, the meta information 112 includes search keyword information depending on a search basis and location information about a location of AV data. As shown in FIG. 1, the meta information 112 indicates exact locations of parts of the AV data (i.e., the clip AV stream 140) with reference to the play items 120a, 120b, and 120c and the clip information 130. Hence, various search functions are provided according to search information included in the meta information 120. The meta information 112 is included in the play list mark 111. Other types of meta information 112 will be described below.

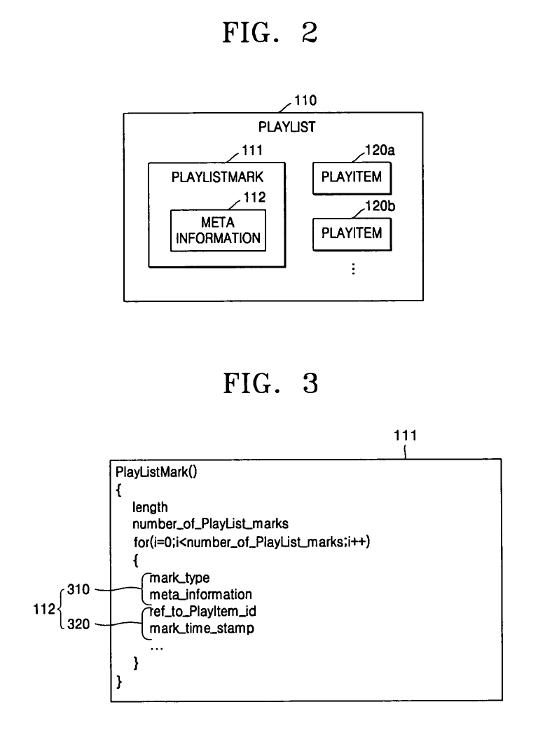

A data structure of the meta information 112 will now be described in greater detail with reference to FIG. 2. FIG. 2 is a block diagram schematically illustrating a data structure of the play list 110 including the meta information 112 according to an aspect of the invention. Referring to FIG. 2, the play list 110 includes the play list mark 111 and at least one play item 120a, 120b, 120c . . . , or the like. The play list mark 111 includes the meta information 112 for providing an extended search function according to an aspect of the invention. As described above, the play item 120a (120b) includes information for reproducing a part of the AV data.

The play list mark 111 includes a mark used upon a chapter change, a mark indicating a point in time when a still image is changed in an application (such as a browsable slide show), and a mark indicating a playback point in time pointed out by a navigation command word (such as LinkMK). Accordingly, a specific part of the data corresponding to a designated point in time, such as, a point in time when a chapter is selectively reproduced, a point in time when a slide show of a still image is changed, or the like, can be reproduced as in a conventional art.

However, the play list mark 111 cannot provide various search and playback functions according to various search bases, such as, a scene-by-scene search basis, a character-by-character search basis, a location-by-location search basis, a music-by-music basis, an item-by-item search basis, and the like.

On the other hand, the meta information 112 provides an extended search function according to the various search bases. To provide the extended search function, the meta information 112 includes search keyword information and location information. The search keyword information is compared with a search basis desired by a user to search for a play list mark including meta information matched with the search basis. If a matched play list mark 111 is found, a location of the AV data corresponding to the location information included in the matched play list mark 111 is searched for and played back.

FIG. 3 illustrates an example of a sentence structure of the play list mark 111 including the meta information 112. Referring to FIG. 3, the play list mark 111 includes “number_of_PlayList marks” indicating the number of play list marks defined in a single play list and “length” indicating a data length of each of the play list marks. The play list mark 111 further includes the meta information 112 of the shown meta information 112 includes search keyword information 310, which is used to provide an extended search function, and location information 320, which is used to search the AV data for a location corresponding to the result of the extended search.

The shown search keyword information 310 includes a search keyword “mark_type” and a meta information “meta_information”. The “mark_type” search keyword is to be compared with a predetermined search condition. The meta information “meta_information” indicates a value of the search keyword and/or additional information about the search keyword.

The location information 320 includes a play item identifier “ref_to-PlayItem_id” and time stamp data “mark_time_stamp”.

When a specific search condition is received from an external source (for example, when a user inputs a specific search condition using an input device such as a keyboard or remote control), a playback device according to an embodiment of the present invention searches for a mark corresponding to the input search condition by referring to the meta information 112 included in the play list mark 111. If a mark matched with the input search condition is found, the playback device moves to an appropriate location within a clip 135 by referring to the play item identifier (i.e., “ref_to_play item_id” in FIG. 3) and time stamp data included in the location information 320 of the found mark and reproduces the AV data from the location.

The play list mark 111 of FIG. 3 includes a simple form of the meta information 112. In the play list mark 111, a parameter representing an extended search basis is additionally defined in a search keyword (“mark_type”) table to be described later, using a data structure of a conventional play list mark. An 8-bit reserved area of a field of the play list mark 111 is used as a field for the meta information data “meta_information”.

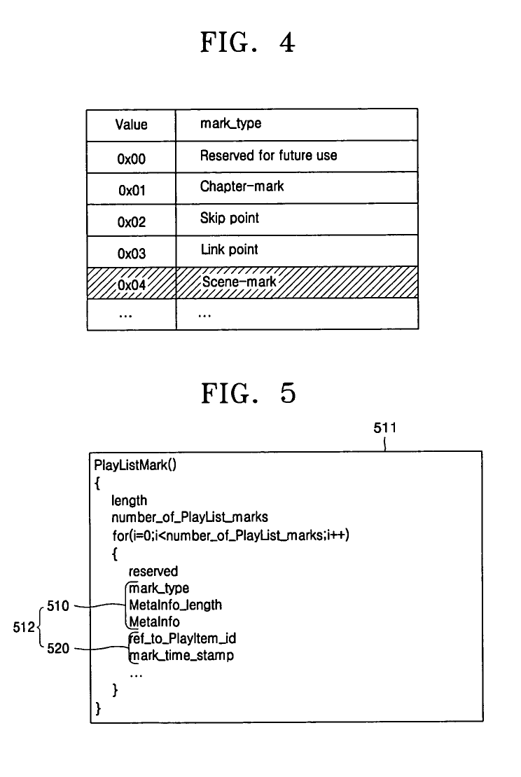

If a basis for a search by scenes of a movie is used as meta information 112 according to an aspect of the invention, a search keyword (“mark_type”) table defined as in FIG. 4 can be used. FIG. 4 illustrates a table for the search keyword “mark_type” according to the meta information 112.

Referring to FIG. 4, “scene-mark” with value 0x04 is defined as a search keyword for a scene-by-scene search according to an aspect of the invention. According to an aspect, a scene number is recorded in the field for the meta information data “meta information”. When a user inputs a scene number of a desired scene, a mark having a “mark_type” field with value 0x04 and a “meta_information” field including the same scene number as the input scene number is searched from a plurality of play list marks 111.

Alternatively, when a value 0x04 of “Scene-mark” is input as a search keyword to perform a scene-by-scene search according to an aspect of the invention, all marks that store search keywords with value 0x04 are searched for. The found marks are displayed in the form of a menu or the like so that the user can select a desired scene from the menu. The menu can be displayed on a screen integral to or connect with the reproducing apparatus.

Then, a play item identifier “ref_to_PlayItem_id” and time stamp data “mark_time_stamp”, which indicates a time interval between a point in time when a play item 120a, 120B, 120c corresponding to the play item identifier starts being reproduced and a point in time included in a found mark or a stamp of a time when a location on the storage medium pointed by the meta information 112 is played back, are extracted from a play list mark 111 having the scene number selected by the user. Using these extracted data items, a location to be played back is moved to a location corresponding to the scene desired by the user.

In FIG. 4, a chapter-mark denotes a mark used upon a chapter change, a skip point denotes a mark which indicates a point in time when a still image is changed in an application, such as a browsable slide show, and a link point denotes a mark which indicates a playback point in time indicated by a navigation command (such as, LinkMK) according to aspects of the invention.

Various search bases other than the scene-by-scene search basis can be used according to an aspect of the invention. For example, a character-by-character search basis, a location-by-location search basis, a music-by-music search basis, an item-by-item search basis, and the like, can be considered to provide an extended search function according to aspects of the invention.

A data structure of meta information 512 according to another embodiment of the present invention will now described in detail. FIG. 5 illustrates an example of a sentence structure of a play list mark 511 including the meta information 512. In the play list mark 511, an additional search basis for the meta information 512 is defined in a search keyword information 510 “mark_type”. Additionally, the search keyword information 510 includes a meta information data (“MetaInfo”) field storing meta information with a variable data length and a meta information length (“MetaInfo_length”) field storing a length of the meta information data “MetaInfo”. A location information 520 is further included in the meta information 512 and includes a play item identifier “ref_to_PlayItem_id: and time stamp data “mark_time_stamp”.

If a scene of a movie is used as the meta information 512, the scene-mark of the table of FIG. 4, which is a search keyword “mark_type” for a scene-by-scene search, is defined, a scene number and additional description about the scene are recorded in the “MetaInfo” field, and a length of the meta information data “MetaInfo” is recorded in the “MetaInfo_length” field. Hence, the play list mark 511 of FIG. 5 can store meta information 512 with a variable length instead of with a fixed length as in the play list mark 111 of FIG. 3, so that the meta information data” “MetaInfo” can include more and various types data.

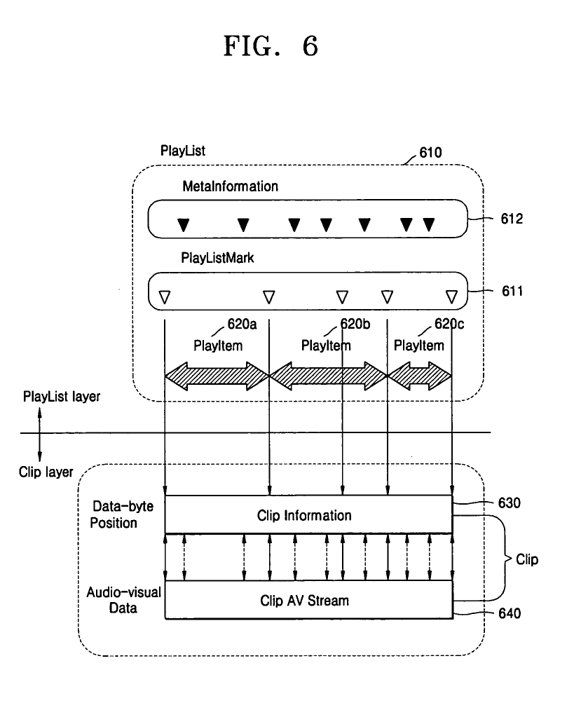

A data structure of meta information 612 according to still another embodiment of the present invention will now be described in detail in conjunction with FIG. 6. FIG. 6 illustrates a relationship between the meta information 612 and the AV data 640. In contrast with the meta information 112 and 512 according to the embodiments of FIGS. 3 and 5, the meta information 612 is defined separately from a play list mark 611. In other words, a play list 610 includes the meta information 612 recorded independently of the play list mark 611. As described above, items included in the meta information 612 indicate exact locations within the AV data 640 with reference to play items 620a, 620b, and 620c and clip information 630.

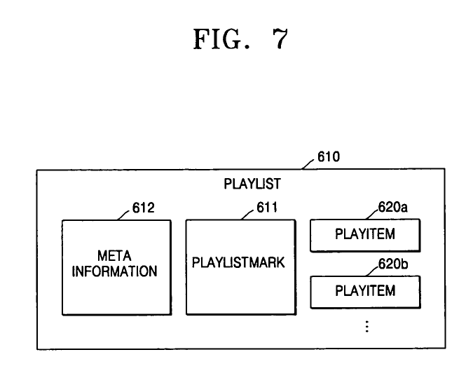

FIG. 7 is a block diagram schematically illustrating a data structure of the play list 610 including the meta information 612 according to an aspect of the invention. Referring to FIG. 7, the play list 610 includes the play list mark 611 and at least one play item 620a, 620b, . . . , or the like. The meta information 612 provides an extended search function, is included in the play list 610, separately from the play list mark 611. The play list mark 611 and the play item 620a (620b, . . . , or the like) are otherwise the same as or similar to the play list mark 111 and the play item 120a (120b, . . . , or the like) of FIG. 2.

The meta information 612 provides various search functions according to various search bases. The meta information 612, which is used to provide an extended search function, includes search keyword information and location information. The search keyword information is compared with a search basis desired by a user to search for a meta information item matched with the desired search basis. If a matched meta information item is found, a location on the AV data 640 corresponding to location information included in the found meta information item is searched for and played back.

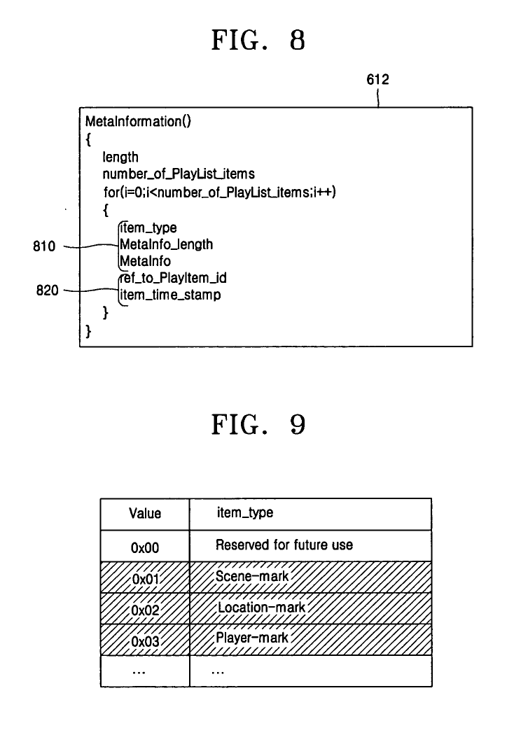

FIG. 8 illustrates an example of a sentence structure of the meta information 612, which is recorded separately from the play list mark 611 according to an aspect of the invention. Referring to FIG. 8, a data structure “MetaInformation” is defined to form the meta information 612. In the data structure “MetaInformation”, a term “item” is used as a unit indicating each of search targets that constitute the meta information 612.

The data structure “MetaInformation” of the meta information 612 includes “number_of_PlayList_Items” indicating the number of meta information items defined in a single play list 610 and “length” indicating a length of each meta information 612.

Each of the meta information items includes, as a search keyword information 810 for providing an extended search, a search keyword “item_type” to be compared with a predetermined search condition, meta information data “MetaInfo” indicating a value of the search keyword and/or additional information about the search keyword, and length information “MetaInfo_length” indicating a length of the meta information data “MetaInfo”. Each of the meta information item also includes, as location information 820 for searching the AV data 640 for a location corresponding to a result of the extended search, a play item identifier “ref_to-PlayItem_id” and time stamp data “mark_time_stamp”.

If a basis for a search by scenes of a movie is used as meta information 612 by way of example, a search keyword (“item_type”) table defined as in FIG. 9 is used according to an aspect of the invention. FIG. 9 illustrates a table for the search keyword “item_type” of the meta information 612. Referring to FIG. 9, a scene-mark, which is a search keyword for a scene-by-scene search, is defined as value 0x01. A scene number and/or an additional description about a scene are recorded in the “MetaInfo” field. A length of the field for the meta information data “MetaInfo” is recorded in the field for the length information “MetaInfo_length”.

In FIG. 9, “Scene-mark” has a value of 0x01 and is defined as a scene-by-scene search type. “Location-mark” has a value of 0x02 is defined as a location-by-location search type. “Player-mark” has a value of 0x03 and is defined as a player-by-player or character-by-character search type. The value 0x00 is reserved. Various search types other than the scene-by-scene and location-by-location search types, such as, a music-by-music search type, an item-by-item search type, combinations thereof, and the like, may be further defined in the table of FIG. 9 to provide an extended search function. Moreover, it is understood that other types of tables can be used in addition to or instead of the table in FIG. 9.

For example, if a user inputs a scene number of a desired scene, a meta information item having an search keyword (“item_type”) field with value 0x01 and a meta information data (“MetaInfo”) field storing the same scene number as the input scene number is searched from a plurality of meta information items. Alternatively, when value 0x01 corresponding to Scene-mark is input as a search keyword to perform a scene-by-scene search, all meta information items that store search keywords with value 0x01 are searched for. The found meta information items are displayed in the form of a menu or the like so that the user can select a desired scene from the menu.

Then, an identifier of a play item “ref_to_PlayItem_id”, a point in time when the corresponding play item 620a, 620b, 620c starts being reproduced, and time stamp data “mark_time_stamp” are extracted from a meta information item having the scene number selected by the user. Using these extracted data, a location to be played back is moved to a location corresponding to the scene desired by the user.

When the meta information 112, 512 is included in a play list mark 111 and 511 as in the embodiment of FIGS. 3 and 5, all data included in the play list mark 111 and 511 are searched to find a meta information item matched with a search condition input by the user. However, when meta information 612 is recorded separately from a play list mark 611 as in the embodiment of FIG. 6, only the meta information 612 is searched, thereby increasing the efficiency of searching.

By defining a separate data structure “MetaInformation”, a storage medium is free of several restrictions that may be caused when a field for storing meta information is added to a play list mark structure as in a conventional art. As such, the separate data structure can be separately recorded after the play list marks are defined, such as can occur when an updated search is retrieved for use with the storage medium.

In summary, each of the embodiments of FIGS. 3 and 5 is a case where meta information 112, 512 is included in the play list mark 111, 511 (shown as “PlayListMark( )” in FIGS. 3 and 5), and the embodiment of FIG. 6 is a case where meta information 612 (shown as “MetaInformation( )” in FIG. 8) is defined separately from the corresponding play list mark 611. In other words, in the embodiments of FIGS. 3 and 5, a “PlayListMark( )” including meta information 112, 512 and defines an additional type indicating a search keyword of meta information in a “mark_type” field indicating a type of mark and defines a “MetaInfo” or “meta_information” field and a “MetaInfo_length” field indicating a length of the “MetaInfo” or “meta_information” field as fields indicating the meta information. In this case, types of search keyword of meta information to be searched for must be pre-defined, and search keywords “mark_type” designated according to the predefined search keyword types must also be pre-defined. If the types of search keywords of the to-be-searched meta information are a scene, a character, an item, and a music, values of “mark_type” fields must be pre-defined, like, value 0x04 for “mark_type” indicating a scene, value 0x05 for “mark_type” indicating a character, value 0x06 for “mark_type” indicating an item, and value 0x07 for “mark_type” indicating music.

On the other hand, in the embodiment of FIG. 7, a meta information structure “MetaInformation( )” is defined separately from a play list mark 611. Even in this case, a value of a “mark_type” field indicating each search keyword must be pre-defined as shown in FIG. 9.

However, in the shown embodiments the present invention, “item_type” indicating a type of a search keyword of meta information may not be pre-defined but arbitrarily defined by a manufacturer. Therefore, other types of items, such as viewing angles, music types, items for sale, coming attractions/advertisements, etc . . . can be defined without restriction. Moreover, it is understood that the “item_type” can be defined by entities other than the manufacturer, such as by a distributor, leaser, and/or end user according to aspects of the invention.

Applications of the embodiments of meta information 112, 512, 612 of FIGS. 1, 3, 5, and 8 are designed so that a type of a search keyword of meta information can be arbitrarily defined by a manufacturer instead of being predefined will now be described. In these applications, a playback device (such as that shown in FIG. 10) must be able to recognize an arbitrarily defined search keyword type to perform a search. To do this, meta type information that can be arbitrarily designated by a manufacturer independently of “mark_type” is needed.

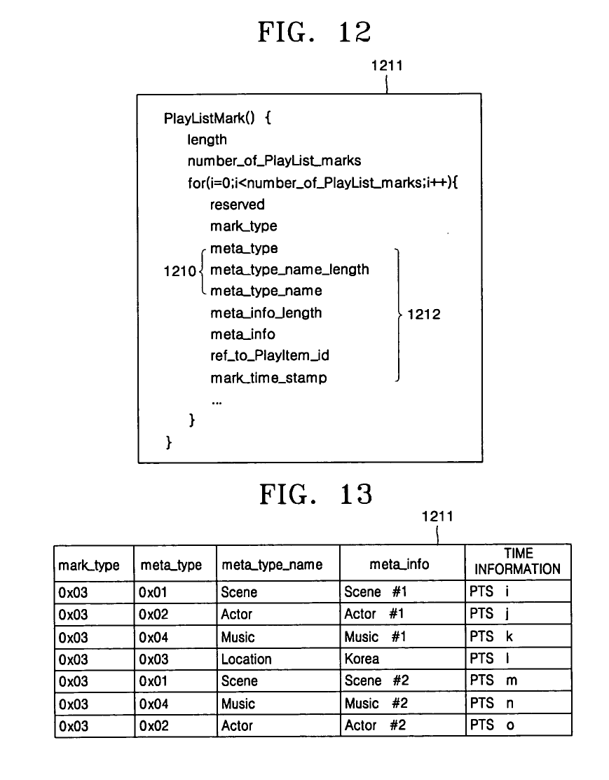

FIG. 12 illustrates an example of a sentence structure of a play list mark 1211 including meta information 1212 according to yet another embodiment of the present invention to which meta type information 1210 is added. The meta information 1212, which is an application of the embodiment of FIG. 5, is obtained by adding the meta type information 1210, which can be arbitrarily designated by a manufacturer and indicates a type of a search keyword of meta information, to the meta information 512 of FIG. 5.

In other words, in contrast with the embodiment of FIG. 5, the meta type information 1210 shown in FIG. 12 is added and defined separately from the mark type “mark_Type” shown in FIG. 5. All marks in the play list mark 1211 that indicate the meta information 1212 have an identical “mark_type” value so as to be distinguished from the play list mark 1211. A type of meta information 1212 is defined in a “meta_type” field, and a name of the meta information type is defined in a “meta_type_name” field. If “mark_type” identifying as meta information 1212 according to the present invention is 0x03, all marks indicating the meta information 1212 have a value 0x3. Values of the “meta_type” and “meta_type_name” fields may be arbitrarily designated by a manufacturer instead of being pre-defined.

If the manufacturer wants to define a scene, a character, a location, and a music as search keywords of meta information, corresponding play list marks 1211 can be defined as shown in FIG. 13. FIG. 13 illustrates an example of play list marks 1211 including meta information 1212 according to a sentence structure of FIG. 12. Referring to FIG. 13, values of “mark_type” of the play list marks 1211, identifying the information as meta information 1212, are all 0x03, and a “meta_type” field is referred to in order to distinguish types of search keywords of meta information from one another. In the “meta_type” field of FIG. 13, the manufacturer sets a scene as 0x01, a character as 0x02, a location as 0x03, and a music as 0x04. Since such meta type information is arbitrarily designated by a manufacturer, a playback device cannot recognize which type of search keyword each of the “meta_type” values indicates. Hence, the playback device refers to a “meta_type_name” field allocated to each of the “meta-type” fields to display supported search keyword types on a screen.

In other words, when the playback device (such as that shown in FIG. 10) displays on the screen a search menu image including supported search keyword types with reference to the “meta_type_name” field, a user selects a search keyword type “meta_type” from the displayed search keyword types. The playback device searches for play list marks 1211 matched with the meta_type selected by the user and displays on the screen a list of selectable search keywords with reference to the meta information data (“meta_info”) field included in the found marks. Thereafter, the AV data corresponding to a search condition desired by the user can be reproduced using a presentation time stamp (PTS) defined in a play list mark 1211 corresponding to a search keyword value selected by the user.

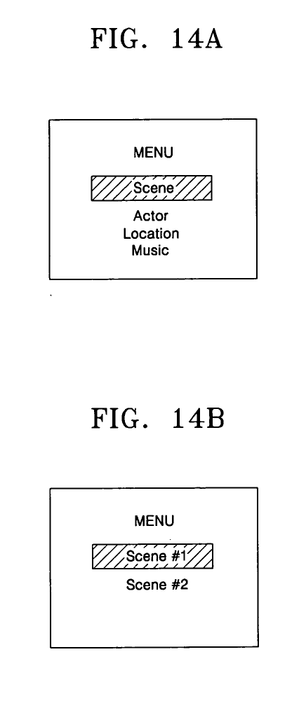

FIGS. 14A and 14B illustrate examples of search menu images formed using meta information according to aspects of the invention. FIG. 14A illustrates an example of the search menu image formed of the supported search keyword types with reference to the “meta type name” field. Referring to FIGS. 13 and 14A, the supported search keyword types are displayed on a screen with reference to the “meta_type_name” field so that a user can select one of the displayed search keyword types. In other words, a scene corresponding to 0x01, an actor corresponding to 0x02, a location corresponding to 0x03, and a music corresponding to 0x04 are displayed on the search menu image. As shown in FIG. 13, for the scene corresponding to 0x01, there are Scenes 1 and 2; for the actor corresponding to 0x02, there are Actors 1 and 2; for the location corresponding to 0x03, there is Korea; and for the music corresponding to 0x04, there are Music items 1 and 2 from which the user can select. For example, if the user wants to search for and play back a motion picture corresponding to a scene number 1, the user can select a search keyword type corresponding to a scene using the menu shown in FIG. 14B.

FIG. 14B illustrates an example of a menu formed of search keyword values in “meta_info” fields corresponding to a search keyword type 0x1 selected by the user using the menu in FIG. 14A. Referring to FIGS. 13 and 14B, the playback device searches for all play list marks 1211 having “meta_type” fields with value 0x1, which corresponds to the scene-by-scene search indicated in the search keyword type selected by the user. Referring to FIG. 13, first and fifth marks having meta_type with a value 0x1 are found. The playback device can display on the screen the found search keyword values in the form of a menu as shown in FIG. 14B. When the user can select scene #1 from the displayed search keyword values, the playback device reads out time information corresponding to the scene #1 of FIG. 13 and plays back a motion picture corresponding to the scene #1 according to the read-out time information. While not required, it is understood that the menus can be combined such that searches can be made for combined search types (i.e., scenes in which an actor exists or a particular type of music is being played) in order to refine the results shown in FIG. 14B.

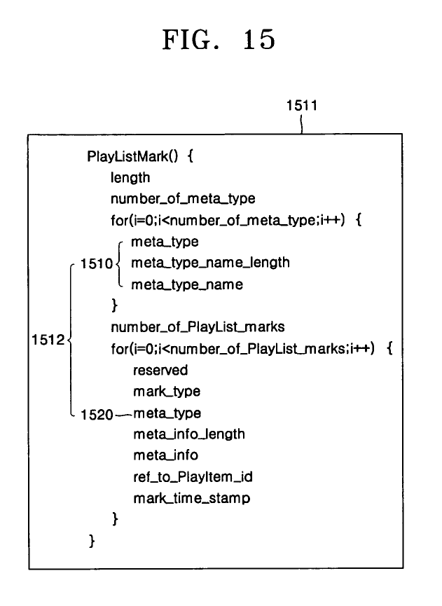

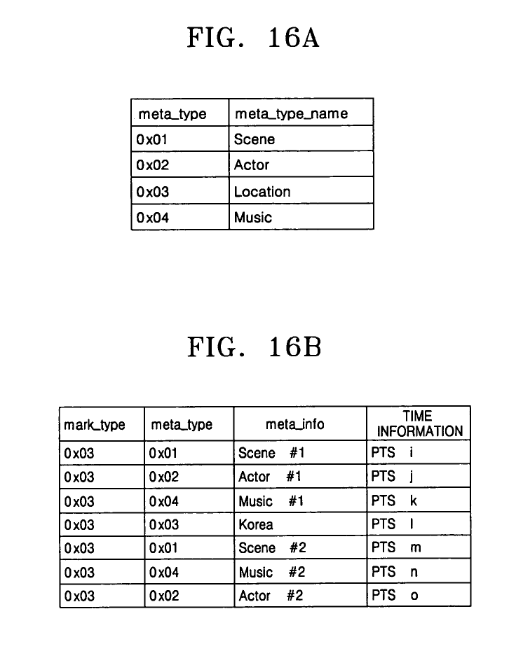

A play list mark designed so that a manufacture can arbitrarily define meta type information, according to another embodiment of the present invention, will now be described. In this embodiment, a list of supported search keyword types is managed independently instead that a search keyword type “meta_type” is defined in each play list mark as in the embodiment of FIG. 13. FIG. 15 illustrates an example of a sentence structure of a play list mark 1511 including meta information 1512 according a further embodiment of the present invention to which meta type list information 1510 is added. Referring to FIG. 15, the meta type list information 1510 indicating supported search keyword types is defined separately from other information defined in the play list mark 1511. Accordingly, the playback device can only search for the meta type list information 1510 without needing to search for all play list marks in order to display on the screen a search menu image including the supported search keyword types, thereby efficiently displaying a search menu image as shown in FIG. 14A. In other words, a list of meta types arbitrarily defined by a manufacturer is recorded separately from information included in a mark so that a search menu image can be more efficiently formed. While shown as words in FIGS. 14A and 14B, it is understood that the search menu could be picture based or include a combination of images and text.

More specifically, when a user inputs a request for searching for meta information 1212, the playback device displays on the screen (not shown) a menu formed of all searchable meta type data with reference to the “meta_type_name” field of the meta type list information 1510. In other words, all supportable search keyword types defined by the manufacturer are displayed. By way of example, the playback device displays a menu such as that shown in FIG. 14A. If the user selects a meta type name from the displayed menu, the playback device searches for marks including meta information whose “mark_type” is 0x3, by referring to “meta type” values corresponding to the selected meta type_name. The playback device selects play list marks 1211 including a meta_type with a selected meta_type value, and displays a menu including the selected marks. By way of example, the playback device displays a menu such as that shown in FIG. 14B. When the user selects meta information 1212 from the displayed menu, the playback device moves an optical pickup to a location to be played back from a location storing the selected meta information and the AV data is played back. It is understood that a similar operation is performed for play list marks 111, 511, 611 and meta information 112, 512, 612.

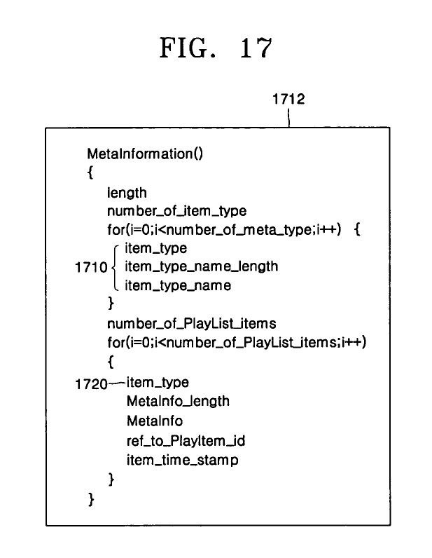

FIGS. 16A and 16B illustrate examples of a play list mark 1511 including meta information based on the sentence structure shown in FIG. 15. FIG. 16A illustrates the meta type list information 1510, indicating supported search keyword types as described above. In FIG. 16A, the meta type list information 1510 including “meta_type” information and “meta type name” information corresponding to the “meta type” information is defined. The “meta type name” information defines four meta types arbitrarily defined by a manufacturer, which are a scene, an actor, a location, and a music in the shown embodiment. However, it is understood that other types can be chosen, such as types referring to products being sold, games, or hypertext lines or other such items storable on the medium.

FIG. 16B illustrates marks of meta information corresponding to the search keyword type selected from the search menu image of FIG. 14A. In other words, marks including meta type information depending on the search keywords “meta_type” shown in FIG. 16A are illustrated in FIG. 16B.

An application of the embodiment of FIG. 6, in which meta information is defined separately from a play list mark, will now be described with reference to FIG. 17. FIG. 17 illustrates an example of a sentence structure of meta information 1712 according to another embodiment of the present invention which is recorded separately from a play list mark and additionally includes meta type information 1710. Referring to FIG. 17, a “MetaInformation(” structure is recorded separately from a “PlayListMark( )” structure and designed so that a manufacture can arbitrarily define types of meta information. Each field of the “MetaInformation( )” structure is the same as described above with reference to FIG. 15.

A playback device for playing back a storage medium including meta information having each of the above-described data structures will now be described in regard to FIG. 10. While described as a playback device, it is understood that the device can also be a recording apparatus that records data with respect to the storage medium.

FIG. 10 is a block diagram of a playback device according to an embodiment of the present invention. Referring to FIG. 10, the playback device includes a read unit 1020, a buffer unit 1030, a search unit 1040, and a playback unit 1050. The read unit 1020 reads out the AV data and at least one piece of meta information from a storage medium 1010. The buffer unit 1030 temporarily stores the read-out AV data and the read-out meta information and transmits the read AV data and meta information to the playback unit 1050. While shown as using the buffer unit 1030, it is understood that the playback device may not include the buffer unit 1030 in all aspects of the invention, such as when buffering is not needed because of a high performance of the read unit 1020.

The search unit 1040 searches for a location of the AV data that satisfies an externally input search condition, by referring to the meta information included in the storage medium 1010 to serve as a basis for searching for the AV data. In other words, the search unit 1040 receives the meta information from the read unit 1020, compares the externally input search condition with search keyword information included in the meta information, and transmits to the playback unit 1050 information about a location of AV data included in a meta information item or a play list mark that are matched with the search condition.

Particularly, to receive a predetermined search condition, the search unit 1040 displays on a screen (not shown) a search menu formed using the above-described meta type information indicating types of search keyword, ones of which can be arbitrarily designated by a manufacturer. A user can select from the displayed menu that search keyword for the desired AV data to be reproduced. The playback unit 1050 plays back the AV data corresponding to the location information received from the search unit 1040.

A method of playing back a storage medium including meta information according to the present invention will now be described with reference to FIG. 11. While not required, it is understood that the method can be implemented using computer software encoded on a computer readable medium usable with a computer, such as a controller used in the apparatus of FIG. 10 and/or a general or special purpose computer connected or networked to a screen.

FIG. 11 is a flowchart illustrating a playback method according to an embodiment of the present invention. In operation 1120, a predetermined search condition is received to play back a storage medium having at least one piece of meta information that enables an extended search function. In operation 1122, a location of the AV data that satisfies the search condition is searched for with reference to the meta information included in the storage medium. Thereafter, in operation 1124, the AV data is reproduced from the location.

Particularly, to search for the location of the AV data with reference to the meta information, the input search condition is compared with search keyword information included in the meta information to find a meta information item or a play list mark that match with the search condition, and a location of the AV data is searched for with reference to the location information included in the found meta information item or play list mark.

To receive the predetermined search condition in operation 1120 according to an aspect of the invention, a search menu formed using meta type information indicating the search keyword types that a manufacturer can arbitrarily designate may be displayed on a screen so as to categorize the AV data in categories chosen by the manufacturer so as to customize the search of the AV data.

As described above, a storage medium according to aspects the present invention provides an extended search and playback function according to various search bases desired by a user, such as, a scene-by-scene search, a character-by-character search, a location-by-location search, and the like. Thus, AV data conforming to various search conditions desired by the user can be effectively searched for and played back.

As described above, storage media according to embodiments of the present invention store audio-visual (AV) data and a plurality of pieces of meta information that serve as a basis for searching for the AV data. Hence, it is possible to search for and play back a motion picture according to various search bases. Additionally, the storage medium according to an embodiment of the present invention may include a plurality of pieces of meta information that serve as a basis for searching for AV data so that a location on AV data that satisfies a predetermined search condition is searched for and played back. Thus, the storage medium can provide an extended search function according to various search bases.

The storage medium according to an embodiment of the present invention is preferably attachable to/detachable from a playback device, and is preferably an optical disc from which data can be reproduced using an optical playback device. Examples of the storage medium include CD-ROMs, DVDs, next generation DVDs (such as Bluray or Advanced Optical Discs) and the like and may further include optical discs to be developed in the future. It is understood that the storage medium of aspects of the invention can further include magneto-optical media and magnetic based media.

While described in terms of AV data, it is understood that aspects of the invention can be used with other data types and/or used in non-motion picture contexts, such as video games or audio data reproduction.

While not required, aspects of the invention can also be embodied as computer readable codes on at least one computer readable recording medium for use with at least one computer processor. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While a few embodiments of the present invention has been particularly shown and described with reference to exemplary embodiments thereof, it is understood by those of ordinary skill in the art that various changes in form and details may be made therein without departing from the spirit and principles of the present invention, the scope of which is defined by the following claims and equivalents thereof.

1. A storage medium storing data reproduced using a recording and/or reproducing apparatus, the data comprising:
audio-visual (AV) data;
at least one play item and at least one play list, each of the at least one play item being a unit in which the AV data is reproduced by the recording and/or reproducing apparatus; and
at least one piece of meta information used by the recording and/or reproducing apparatus to search for locations of the AV data that satisfy externally input search conditions, by referring to the play item and the play list.

2. The storage medium of claim 1, wherein the meta information comprises:
search keyword information to be compared by the apparatus with the externally input search condition; and
location information indicating to the apparatus the location of the AV data corresponding to the search keyword information.

3. The storage medium of claim 2, wherein the search keyword information comprises:
a search keyword to be compared by the apparatus with the externally input search condition; and
a value of the search keyword and/or additional information about the search keyword.

4. The storage medium of claim 3, wherein the search keyword comprises at least one of a search keyword for a scene-by-scene search, a search keyword for a character-by-character search, a search keyword for a music-by-music search, a search keyword for an item-by-item search, or combinations thereof.

5. The storage medium of claim 2, wherein the location information comprises:
an identifier of the play item to which the meta information refers; and
time stamp data indicating to the apparatus a time interval between a point in time when the play item starts being reproduced and a point in time corresponding to a location of the AV data to which the meta information pointed or a stamp of a duration while the location of the AV data to which the meta information pointed is being played back.

6. The storage medium of claim 5, wherein:
the play item identifier is used to search for a play item to be played pack; and
the point in time when the found play item starts being reproduced and the time stamp data are used by the apparatus to search for a location of a part of the AV data to be played back.

7. The storage medium of claim 1, wherein the meta information is included in a play list mark, the play list mark comprises a collection of marks indicating locations of specific parts of the AV data that correspond to play lists, and each of the play lists comprises a corresponding one of the units in which the AV data is reproduced.

8. The storage medium of claim 1, wherein the meta information is recorded separately from a play list mark, the play list mark comprises a collection of marks indicating locations of specific parts of the AV data that correspond to play lists, and each of the play lists comprises a corresponding one of the units in which the AV data is reproduced.

9. The storage medium of claim 1, wherein the meta information has a fixed length.

10. The storage medium of claim 1, wherein the meta information is recorded in the form of binary data.

11. The storage medium of claim 1, wherein the meta information has a variable length.

12. The storage medium of claim 1, wherein the meta information is recorded in the form of text data and further comprises an additional description about the meta information.

13. The storage medium of claim 1, wherein the meta information further comprises length information indicating a data length of the meta information.

14. A playback and/or recording device for use in transferring data with respect to a storage medium, the storage medium storing audio-visual (AV) data, at least one play item and at least one play list, each of the at least one play item being a unit in which the AV data is reproduced, and at least one piece of meta information to search for locations of the AV data that satisfy externally input search conditions by referring to the play item and the play list, the apparatus comprising:
a search unit that refers to the at least one piece of meta information read from the storage medium in order to search for a location of the AV data on the storage medium that satisfies an externally input search condition; and
a playback unit reproducing the AV data from the location on the storage medium searched by the search unit and which satisfies the externally input search condition.

15. The playback device of claim 14, further comprising a reading unit which reads the AV data and the meta information from the storage medium.

16. The playback device of claim 15, wherein:
the meta information further comprises search keyword information,
the search unit receives the meta information from the reading unit, compares the externally input search condition with the search keyword information included in the meta information, and transmits to the playback unit information about a location of AV data included in meta information that matches the keyword condition.

17. The playback device of claim 16, wherein the playback unit reproduces the AV data from the location on the storage medium corresponding to the received information about the location of the AV data that satisfies the externally input search condition.

18. A playback method comprising:
receiving a search condition;
searching a storage medium for a location of audio-visual (AV) data on the storage medium that satisfies the received search condition by referring to at least one piece of meta information read from the storage medium, the at least one piece of meta information comprising information used to search for the locations of the AV data that satisfy predetermined search conditions; and
reproducing the AV data from the searched location on the storage medium that satisfies the search condition by referring to at least one play item and at least one play list read from the storage medium, each of the at least one play items is a unit in which the AV data is reproduced from the storage.

19. The playback method of claim 18, wherein:
the meta information comprises search keyword information, and
the searching of the storage medium comprises:
comparing the search condition with the search keyword to find the meta information that matches with the search condition; and
searching for the location of a part of the AV data that satisfies the search condition, by referring to the found meta information.

20. The storage medium of claim 3, wherein the search keyword information further comprises meta type information that indicates and distinguishes between a type of the search keyword that is arbitrarily designated by a manufacturer and another type of the search keyword that is not arbitrarily designated by the manufacturer.

21. The storage medium of claim 20, wherein the meta type information comprises at least one datum of a meta type indicating the type of the search keyword, additional information about the meta type, a length of the additional information, or combinations thereof.

22. The storage medium of claim 20, wherein the search keyword to be compared with the search condition has a fixed value.

23. The storage medium of claim 2, wherein the meta information further comprises meta type information that indicates and distinguishes between a type of the search keyword that is arbitrarily designated by a manufacturer and another type of the search keyword that is not arbitrarily designated by the manufacturer.

24. The storage medium of claim 23, wherein the meta type information comprises at least one datum of a meta type indicating the type of the search keyword, additional information about the meta type, a length of the additional information, or combinations thereof.

25. The storage medium of claim 23, wherein the search keyword defined in the search keyword information and to be compared with the search condition has a fixed value.

26. The playback device of claim 16, wherein:
the meta information recorded in the storage medium further comprises meta type information that indicates and distinguishes between a type of the keyword that is arbitrarily designated by the manufacturer and another type of the search keyword that is not arbitrarily designated by the manufacturer; and
the search unit displays on a screen a search menu based on the meta type information to receive a search condition from an external source.

27. The playback method of claim 18, wherein:
the meta information further comprises meta type information that indicates and distinguishes between a type of the keyword that is arbitrarily designated by the manufacturer and another type of the search keyword that is not arbitrarily designated by the manufacturer, and
the receiving of the predetermined search condition comprises displaying a search menu on the screen based on the meta type information and which is used to receive the search condition.

28. A storage medium storing data reproduced using a recording and/or reproducing apparatus, the data comprising:
data to be reproduced by the recording and/or reproducing apparatus;
at least one play list comprising at least one play item, each of the at least one play item being a unit in which the data is reproduced by the recording and/or reproducing apparatus; and
at least one piece of meta information used by the recording and/or reproducing apparatus to search for a location of a portion of the data on the storage medium based upon a comparison of a search condition and the at least one piece of meta information, the meta information referring to the play item and the play list.

29. The storage medium of claim 28, wherein:
the play list comprises play list marks which the apparatus uses to selectively search for and reproduce a portion of the data, and
the meta information comprises a mark type indicating a type of a portion of the data to be reproduced and a meta mark other than the play list marks that is defined according to the mark type and which the apparatuses uses to selectively search for and reproduce a portion of the data within the play item and which is not located at the play list marks.

30. The storage medium of claim 29, wherein the play list mark comprises a mark indicating a chapter change, a mark indicating a point in time when a still image is changed in an application, and/or a mark indicating a playback point in time pointed out by a navigation command word.

31. The storage medium of claim 30, wherein the meta type is configurable to indicate at least one of a plurality of different types of data and which the apparatus uses to sort and categorize portions of the data according to the different types.

32. The storage medium of claim 31, wherein the meta information comprises information used to distinguish between different portions data for each of the different types of the data such that, when the apparatus receives a search request for a particular type of data from the different types which can be indicated, the apparatus searches the meta type to isolate the type of data matching the particular type, and uses the information to identify the data portions of the particular type.

33. The storage medium of claim 28, wherein the play list comprises the play list marks and the meta information.

34. The storage medium of claim 28, wherein the play list comprises the play list marks disposed in a first area and includes the meta information in another area other than the first area such that the apparatus detects the meta information in the another area other than the first area including the play list marks.

35. The storage medium of claim 32, further comprising meta type information that indicates to the apparatus the type of the meta information and which is configurable by a manufacturer to indicate one of a plurality of search categories according to the design of the manufacturer.

36. The storage medium of claim 35, further comprising meta type length information that indicates to the apparatus a length of the corresponding type of the meta information, the length being configurable by the manufacturer to indicate one of a plurality of lengths according to the design of the manufacturer.

37. The storage medium of claim 28, wherein the storage medium is prepared by:
designating the data to be reproduced by the recording and/or reproducing apparatus;
designating and defining the at least one play item and the at least one play list, each of the at least one play item being a unit in which the data is to be reproduced by the recording and/or reproducing apparatus;
designating playlist marks according to a predetermined standard; and
designating meta marks to be included in the at least one piece of meta information and which indicates to the recording and/or reproducing apparatus to search for the location of a portion of the data on the storage medium and which are not included in the predetermined standard.

38. A computer readable medium encoded with processing instructions for implementing a playback method of claim 18 performed by a computer.
